(19) United States
(12) Patent Application Publication
(10) Pub. No.: US 2026/0348458 A1
(43) Pub. Date: Nov. 5, 2026

(54) METHOD FOR PRODUCING A SCREW MECHANISM, METHOD FOR PRODUCING AN INTERNALLY THREADED PART, SCREW MECHANISM, INTERNALLY THREADED PART, MEDICAL TOOL COMPRISING A SCREW MECHANISM, AND USE OF A SCREW MECHANISM

(71) Applicant: ADMEDES GMBH, Pforzheim (DE)

(72) Inventors: Stefan ZENDE, Karlsruhe (DE); Martin Richard BAUMANN, Östringen (DE); Moritz POHLER, Mönsheim (DE)

(21) Appl. No.: 19/489,755

(22) PCT Filed: Apr. 11, 2024
(86) PCT No.: PCT/EP2024/059785

§ 371 Date: Dec. 3, 2025

(30) Foreign Application Priority Data
Jun. 7, 2023 (DE) 10 2023 115 079.0

(51) Int. Cl. F16H 25/24; B23K 26/38; B23K 101/00

(52) U.S. Cl. CPC F16H 25/24; B23K 26/38; B23K 2101/008; F16H 2025/2481

(57) ABSTRACT

The present application relates to a method for producing a screw gear (60), to a method for producing an internally threaded part (40), to a screw gear (60), to an internally threaded part (40), to a medical tool (1) comprising at least one screw gear (60), and to the use of a screw gear (60), wherein the method for producing the screw gear comprises the following steps:—providing an elongated blank (10), such as a wire or a tube, for example;—laser-cutting a spiral (20) from the elongated blank (10) such that the remainder (52) of the elongated blank (10) forms an externally threaded part (50) of the screw gear (60) having an external thread corresponding to the cut-out spiral (20),—fixing the spiral (20) to an outer tube (30) to form an internally threaded part (40) of the screw gear (60), corresponding to the externally threaded part (50) of the screw gear (60).

The present invention relates to a method for producing a screw gear, a method for producing an internally threaded part, a screw gear, an internally threaded part, a medical tool comprising a screw gear, and the use of a screw gear.

Screw gears are known from vices, for example, wherein by turning a spindle with an external thread, one or two clamping jaws, of which at least one clamping jaw has a corresponding internal thread, can be moved towards and away from each other, for example.

Furthermore, various methods for producing external threads are known, such as by machining or laser cutting or laser material processing of an external thread. To produce internal threads, it is particularly known to use a machining tap. The correspondingly produced internal and external threads can in particular represent a screw gear by being engaging with each other. Furthermore, it is known, for example, to produce internal threads by means of electroerosion using threaded electrodes.

Based on conventional methods for producing a screw gear, it is the object of the present invention to provide an improved and particularly efficient method for producing screw gears, in particular to provide a method for producing screw gears with comparatively small diameters.

Furthermore, it is the object of the present invention to provide an improved and particularly efficient method for producing an internally threaded part, in particular to provide a method for producing an internally threaded part with a comparatively small diameter and/or with a comparatively large length.

Moreover, it is the object to provide an improved and particularly efficient screw gear, in particular with a comparatively small diameter and/or with a comparatively large length, to provide an improved internally threaded part, in particular with a comparatively small diameter and/or with a comparatively large length, which can be used for such a screw gear for example, and to provide a medical tool with such a screw gear.

The objects described above are achieved by the subject matter of the independent claims, preferred embodiments are subject of the dependent claims.

A first aspect of the invention relates to a method for producing a screw gear, the method comprising the steps of:
providing an elongated blank, such as a wire or a tube;
laser cutting a spiral or helix or spiral coil from the elongated blank such that the remainder of the elongated blank forms an externally threaded part of the screw gear, substantially with an external thread corresponding to the cut-out spiral; and
fixing the spiral to an outer tube to form an internally threaded part of the screw gear, substantially corresponding to the externally threaded part of the screw gear.

A further aspect of the invention relates to a method for producing an internally threaded part, which can be used for a screw gear as described herein, for example, the method comprising the steps of:
providing an elongated blank, such as a wire or a tube;
laser cutting a spiral or helix or spiral coil from the elongated blank; and
fixing the spiral to an outer tube to form the internally threaded part.

Unless otherwise stated, the following statements refer both to the method for producing the screw gear and to the method for producing the internally threaded part.

By laser cutting the spiral or helix or spiral coil from the elongated blank, wherein the spiral or helix or spiral coil is reused for fixing to the outer tube to form the internally threaded part of the screw gear, an improved method for producing a screw gear or an internally threaded part can advantageously be provided, wherein the screw gear is produced in a particularly resource-saving manner and can therefore be produced in a particularly efficient manner. The internally threaded part can also be advantageously manufactured in a simple manner, and in particular by simultaneously providing an externally threaded part with an external thread corresponding to the internal thread of the internally threaded part, in a resource-saving and therefore particularly efficient manner.

In other words, in the present case, a method can advantageously be provided by laser cutting and the subsequent fixing of the spiral or helix or spiral coil to the outer tube, wherein two mutually complementary threaded parts, i.e. an internally threaded part and an externally threaded part, can be provided by means of a (preferably single) thread cutting step.

Put differently, in the present case, in particular a spiral or helix or spiral coil that occurs as a waste product during external thread cutting can advantageously be reused by laser cutting and the subsequent fixing of the spiral or helix or spiral coil to the outer tube, whereby a resource-saving and particularly efficient method for producing a screw gear or for producing complementary internal thread and externally threaded parts, which can be used in particular for a screw gear, is provided.

The screw gear comprises in particular the internally threaded part and the externally threaded part, wherein the externally threaded part and the internally threaded part are at least partially in mutual engagement. For example, the internally threaded part and the externally threaded part can form a screw gear in which at least some of the tums of the internally threaded part and at least some of the turns of the externally threaded part are in mutual engagement.

In particular, laser cutting can advantageously ensure that the spiral or helix or spiral coil cut or cut out of the elongated blank is substantially maintained, i.e. is maintained continuously, in particular as a large number of consecutive turns.

In particular, compared to conventional thread cutting, in which the internal tap can only be drilled over a limited length, it is also advantageously possible to produce an internal thread with a comparatively large length and/or a comparatively small diameter, in particular without being subject to the risk of the tap breaking off or the thread being inaccurate.

In addition to activating the laser to cut the elongated blank, laser cutting can in particular include carrying out a relative movement of the laser relative to the elongated blank, for example a movement of the elongated blank relative to the laser.

The relative movement of the laser relative to the elongated blank can for example comprise a feed movement of the laser substantially in the axial direction relative to the elongated blank, and/or comprise a relative rotational movement of the laser around the elongated blank, for example substantially in the circumferential direction of the elongated blank, and/or comprise a relative tilting movement of the laser relative to the axis of the elongated blank, for example to change the inclination of the laser relative to the axis of the elongated blank.

The relative movement of the laser relative to the elongated blank and in particular the movement of the elongated blank relative to the laser can further comprise a feed movement of the elongated blank substantially in the axial direction relative to the laser, and/or comprise a rotation of the elongated blank substantially about its axis, in particular while the laser is pointing off-center at the elongated blank.

The relative movement of the laser relative to the elongated blank and in particular the movement of the elongated blank relative to the laser preferably comprises in particular a combination of a feed movement of the elongated blank substantially in the axial direction relative to the laser and a rotation of the elongated blank substantially about its axis, in particular while the laser is pointing at the elongated blank off-center.

The combination of the relative movement of the laser relative to the elongated blank advantageously facilitates obtaining the spiral or helix or spiral coil, in particular obtaining the spiral or helix or spiral coil as a single piece cut from the elongated blank. It is understood that, for example, to produce a plurality of spirals or helices or spiral coils, in particular with different axial lengths and/or with different numbers of turns and/or with different pitches, the spirals or helices or spiral coils cut out by means of laser cutting can be cut out with a separation from one another.

Furthermore, the spiral or helix or spiral coil can advantageously be provided with application-specific flank heights, application-specific flank angles, and/or application-specific flank shapes by laser cutting the spiral or helix or spiral coil.

Based on the flank height and/or the flank shape of the spiral or helix or spiral coil, the stiffness and flexibility of the spiral or helix or spiral coil can advantageously be adjusted.

Based on the flank shape and/or the flank angle, the force for rotating the internally threaded part relative to the externally threaded part can advantageously be adjusted.

The force for rotating the internally threaded part relative to the externally threaded part can also advantageously be adjusted by fixing the spiral or helix or spiral coil to the outer tube, in particular taking into account the cutting gap caused by the laser during laser cutting or the cutting thickness of the laser. In other words, an initial clearance or an initial tolerance of the spiral or helix or spiral coil relative to the remainder of the elongated blank can advantageously be defined by means of the laser during laser cutting, in particular based on the cutting gap of the laser.

By fixing the spiral or helix or spiral coil to the outer tube, a final clearance or a final tolerance (e.g. for a corresponding use of the spiral or helix or spiral coil) can advantageously be adjusted. The final clearance or the final tolerance can be adjusted by means of fixing, in particular as being different from the initial tolerance or as being different from the initial clearance.

In this way, the force for rotating the internally threaded part relative to the externally threaded part can advantageously be adjusted by fixing the spiral or helix or spiral coil to the outer tube.

In exemplary embodiments, the outer tube can form a transition fit or a clearance fit relative to the spiral or helix or spiral coil.

In other words, an inner diameter of the outer tube can form a transition fit or a clearance fit relative to the outer diameter of the spiral or helix or spiral coil, which can in particular substantially correspond to the outer diameter of the elongated blank.

By providing a transition fit and preferably a clearance fit, an unloaded or unstressed positioning of the spiral or helix or spiral coil in the outer tube can advantageously be ensured.

In other words, by providing a transition fit and preferably a clearance fit of the outer diameter of the spiral or helix or spiral coil with the inner diameter of the outer tube, the original shape of the spiral or helix or spiral coil, as cut from the elongated blank, can advantageously be obtained when positioning the spiral in the outer tube. In other words, the original shape, in particular the original pitch of the spiral or helix or spiral coil, as cut from the elongated blank, can advantageously be obtained before fixing.

The spiral or helix or spiral coil forms in particular the internal thread in the outer tube, i.e. the internal thread of the internally threaded part.

Accordingly, by providing a transition fit and preferably a clearance fit, a formation of the internal thread substantially corresponding to the externally threaded part can be ensured by the unloaded positioning of the spiral or helix or spiral coil in the outer tube.

In alternative embodiments, the outer tube can form an interference fit or press fit relative to the spiral or helix or spiral coil.

This can advantageously ensure that the spiral or helix or spiral coil is fixed particularly firmly in the outer tube.

In order to nevertheless ensure that the internal thread is formed in a way that substantially corresponds to the externally threaded part by positioning the spiral or helix or spiral coil in the outer tube, in exemplary embodiments, the spiral or helix or spiral coil can be positioned along openings in the peripheral wall of the outer tube before the step of fixing the spiral or helix or spiral coil.

In further exemplary embodiments, in order to ensure that the internal thread is formed in a way that substantially corresponds to the externally threaded part by positioning the spiral in the outer tube, the spiral can be inserted at least partially into the press-fit or interference-fit outer tube, for example together with the remainder of the elongated blank, i.e. together with the externally threaded part, before the step of fixing the spiral. The spiral can in particular be inserted into the outer tube together with the remainder of the elongated blank such that the spiral is positioned along openings in the peripheral wall of the outer tube, i.e. the spiral is in particular positioned in a manner overlapping with the openings in the peripheral wall of the outer tube.

In further exemplary embodiments, in order to ensure that the internal thread is formed in a way that substantially corresponds to the externally threaded part by positioning the spiral in the outer tube, the remainder of the elongated blank, i.e. the externally threaded part, can be screwed at least partially into the press-fit or interference-fit outer tube with spiral before the step of fixing the spiral. Screwing in means a relative rotation of the externally threaded part to the press-fit or interference-fit outer tube with spiral, and can therefore also include a rotation of the press-fit or interference-fit outer tube with spiral onto the externally threaded part.

Screwing of the externally threaded part into the press-fit or interference-fit outer tube with spiral at least in section can for example take place on one side or on both sides, i.e. from a first end of the outer tube and/or from a second end of the outer tube.

The elongated blank can in particular have a substantially round, preferably substantially circular cross-section. In other words, the elongated blank can in particular have a substantially round, preferably substantially circular, outer contour in cross-section. It goes without saying that the elongated blank is not limited to this.

A blank with a substantially round cross-section or a substantially round outer contour advantageously makes laser cutting of the spiral easier and also facilitates any necessary post-processing of the outer contour to ensure use in a screw gear, or even renders post-processing unnecessary.

The elongated blank in particular has a dimension in the axial direction which is many times larger than a dimension of the outer diameter of the elongated blank or a dimension of the cross-section of the elongated blank.

For example, an axial length or an axial dimension of the elongated blank can in particular be at least about twice as large, preferably at least about 10 times as large, particularly preferably at least about 20 times as large, as a dimension of the outer diameter or the cross-section of the elongated blank.

The elongated blank, in the length of which the spiral and/or the remainder of the elongated blank can also be present after laser cutting, can for example have a length of more than about 1 mm, in particular a length of more than 80 mm, preferably of more than 150 mm, more preferably of more than 200 mm, particularly preferably of more than 300 mm.

In exemplary embodiments, the elongated blank can have such an axial length that the remainder of the elongated blank after laser cutting, i.e. the externally threaded part, has at least one thread.

In further exemplary embodiments, the remainder of the elongated blank can be divided or separated so that the externally threaded part has a part of the remainder of the elongated blank or is formed from it.

By means of the corresponding length of the elongated blank, and the particularly corresponding length of the spiral and/or the remainder of the elongated blank, a screw gear that can be used for a medical tool, for example, and in particular ensures a precise travel path, i.e. ensures a precisely adjustable, substantially axial relative movement between the internally threaded part and the externally threaded part of the screw gear, can advantageously be provided.

For example, the medical tool can comprise or be a system for tissue screws.

In further exemplary embodiments, the medical tool can comprise or be components of implants, in particular geometrically adjustable components of implants, alternatively or additionally components for blocking or adjusting predetermined geometries or positions.

In further exemplary embodiments, the screw gear and in particular the internally threaded part, as described herein, can be used for a screw connection that lies outside the medical field of application, for example as a classic connection or fastening, in particular as a frictional and/or positive connection or fastening of two or more parts.

The elongated blank can in particular be a wire or a tube, which in particular has an outer diameter of less than about 5 mm.

While the wire has a solid material, the tube in particular has a cavity with a predetermined inner diameter.

In exemplary embodiments, the cavity of the tube can be used as an exemplary elongated blank to guide further wires and/or tubes and/or actuators through, in particular to form an outer tube for another spindle, which together form another internally threaded part.

The wire as an elongated blank and its solid material advantageously make it possible to provide a particularly stable externally threaded part based on its remainder after laser cutting, and furthermore to adjust a very precise definition of a force-displacement or torque-displacement relationship in order to move the internally threaded part relative to the externally threaded part. This further advantageously improves precise handling of the spiral, for example during medical treatment. Furthermore, a wire as an elongated blank advantageously enables low production costs and correspondingly low semi-finished product costs, in particular compared to the tube.

The tube as an elongated blank and its cavity with a predetermined inner diameter advantageously makes it possible to provide a comparatively light externally threaded part and/or to provide a comparatively flexible externally threaded part, which can be rotated or turned relative to the internally threaded part with comparatively little effort, and thus makes handling easier, for example during medical treatment.

If the elongated blank is a tube, for example, the tube can in particular be provided with an inner diameter that is smaller than an inner diameter that the spiral has. In other words, during laser cutting, the inner diameter of the spiral can in particular be larger than an inner diameter of the tube, provided that the elongated blank is a tube. This advantageously makes it possible for the tube to have a closed outer contour after laser cutting, or in other words to have a continuous or uninterrupted outer contour in the axial direction. This advantageously ensures mutual support of the internally threaded part relative to the externally threaded part.

Laser cutting the spiral from the elongated blank relates to laser cutting the spiral on an outer peripheral side of the elongated blank, so that the remainder of the elongated blank forms the externally threaded part of the screw gear with an external thread corresponding to the cut-out spiral.

The spiral fixed to the outer tube to form the internally threaded part of the screw gear relates in particular to an internally threaded part the internal thread of which corresponds to the external thread of the externally threaded part of the screw gear.

Fixing the spiral to the outer tube to form the internally threaded part of the screw gear can comprise partially or completely fixing the spiral to the outer tube.

Completely fixing the spiral to the outer tube relates in particular to fixing the spiral to the outer tube, wherein each turn of the spiral, which is arranged inside the outer tube, is fixed at at least one point relative to the outer tube.

The partial fixing of the spiral to the outer tube accordingly relates in particular to fixing the spiral to the outer tube, wherein one or more turns of the spiral, which is or are arranged inside the outer tube, is or are not fixed at at least one point relative to the outer tube. In other words, the partial fixing of the spiral to the outer tube relates in particular to fixing the spiral to the outer tube, wherein one or more turns of the spiral, which is or are arranged inside the outer tube, are movable relative to the outer tube.

While the complete fixing of the spiral to the outer tube advantageously enables a precise adjustment of the actuating force for the relative turning or rotation and movement of the externally threaded part and the internally threaded part, the partial fixing, in contrast, enables the screw gear to be provided with additional clearance and/or with additional flexibility.

In the following, various terms will be used repeatedly, the understanding of which is intended to be made easier by the following exemplary descriptions.

Externally threaded part: The externally threaded part has an external thread, i.e. a thread on its outer circumferential side.

Internally threaded part: The internally threaded part has an internal thread, i.e. a thread on its inner circumferential side.

The external thread of the externally threaded part and the internal thread of the internally threaded part can in particular substantially conform or correspond to one another, i.e. correspond to one another such that when the externally threaded part and the internally threaded part are in mutual engagement, the externally threaded part and the internally threaded part can be rotated both clockwise and counterclockwise relative to one another.

The pitch as used herein means in particular an axial distance between two flank tips adjacent in the axial direction, wherein the respective thread or threaded part or the respective spiral does not have to have tips as flanks. In particular in the case of flat flanks of a respective thread or threaded part or the respective spiral, the pitch is therefore an axial distance between the respective axial centers of the flanks adjacent to one another in the axial direction. The pitch can alternatively also be referred to by the term slope commonly used for threads.

A compressed pitch as used herein means in particular a pitch that is shorter or reduced relative to a specific or original pitch.

An extended pitch as used herein means in particular a pitch that is longer or increased relative to a specific or original pitch.

Axial direction: The axial direction is used herein in particular mainly to describe the outer tube, the elongated blank or for the parts of the elongated blank resulting from laser cutting, i.e. for the spiral that is cut from the outer contour of the elongated blank, as well as for the remainder of the elongated blank from which the spiral was cut out. The outer tube, the elongated blank, the spiral, and the remainder of the elongated blank can, in an unloaded position, in particular have an extension substantially in the axial direction. The axial direction can in particular be a direction that substantially corresponds to an axis of the outer tube, the elongated blank, the spiral, and/or the remainder of the elongated blank, similar to an axis of a tubular, rod-shaped or cylindrical or about cylindrical part.

Radial direction: The radial direction is used herein in particular in connection with the diameter of the outer tube, the elongated blank, the spiral, and/or the remainder of the elongated blank, and describes the extension of the respective element in the radial direction. The radial direction can in particular extend substantially perpendicular to the axial direction. In other words, the radial direction can in particular substantially correspond to a radial direction of a tubular, rod-shaped or cylindrical or about cylindrical part.

A circumferential direction can preferably extend substantially perpendicular to the axial direction and/or substantially perpendicular to the radial direction.

The axial direction, the radial direction and the circumferential direction can form a coordinate system, in particular a right-hand system.

If a direction or an angle is indicated with the addition “substantially” or “about”, this addition is to be understood as meaning or to be understood as a deviation from the relevant direction or angle in the range from 0° to 5°.

If a spatial dimension, a spatial relationship or another relationship is indicated with the addition “substantially” or “about”, this addition is to be understood as meaning or to be understood as a deviation from the relevant dimension or the relevant relationship in the range from 0% to 10%.

In preferred embodiments of the method for producing a screw gear or for producing an internally threaded part, in the step of fixing the spiral to the outer tube, i.e. in particular in the step of partial or complete fixing, the spiral can be fixed to the outer tube such that a predetermined number of turns of the spiral, in particular a predetermined number of consecutive turns of the spiral, protrude from the outer tube.

The turns of the predetermined number of turns protruding from the outer tube are in particular not fixed to the outer tube or movable relative to the outer tube.

The predetermined number of turns can in particular protrude from a first and/or a second end of the outer tube.

The turns of the predetermined number of turns protruding from the outer tube have in particular spring-like properties. In other words, the part of the spiral that protrudes from the outer tube can in particular form a spiral spring portion of the internally threaded part. The spiral spring portion can accordingly have spring-like properties, or have spring properties, such as a predetermined spring stiffness.

The spring stiffness of the spiral spring portion can advantageously be adjusted by defining a first number of consecutive turns that are not fixed to the outer tube and that protrude at least partially from the outer tube, i.e. protrude from the first end and/or from the second end of the outer tube. In other words, the internally threaded part has in particular a spiral spring portion comprising a plurality of consecutive turns that are movable relative to the outer tube and that protrude at least partially from the outer tube, in particular protrude from the outer tube in an undeflected state of the spiral spring portion, i.e. protrude from the outer tube without compressing or extending the spiral spring portion.

The stiffness of the spiral spring portion of the internally threaded part can be further advantageously adjusted by screwing the externally threaded part into the internally threaded part, for example by turning or rotating the internally threaded part relative to the externally threaded part, in particular by screwing the externally threaded part at least partially into the spiral spring portion of the internally threaded part.

By screwing the externally threaded part into the spiral spring portion of the internally threaded part, some of the first number of consecutive turns that are not fixed to the outer tube and in particular protrude from the outer tube at least partially can advantageously be restricted in its axial deflectability and in particular be blocked.

The part of the first number of consecutive turns that is restricted in its axial deflectability and in particular is blocked does not have to be an integer part of the first number and can in particular be a precisely adjustable part of the first number.

By screwing the externally threaded part into the internally threaded part, the stiffness of the spiral spring portion of the internally threaded part can be advantageously adjusted. This in turn is advantageously suitable for adjusting a predetermined force that is to result from a predetermined axial compression or extension of the spiral spring portion. As a result, for example, a medical treatment, in particular an actuation, such as an actuation of a medical instrument, for example a knife, or an insertion or removal of a medical insert, for example a stent, can be carried out with a predeterminable force.

Here, the first number of consecutive turns can protrude at one end of the outer tube which is arranged facing a medical instrument or a medical insert, or is arranged facing away from it.

In particular, the stiffness or spring stiffness of the spiral spring portion of the internally threaded part can be increased by increasingly screwing the externally threaded part into the spiral spring portion, and reduced by increasingly unscrewing or increasingly removing the externally threaded part from the spiral spring portion. Moreover, in exemplary embodiments, a medical tool can be compressed or reduced by increasingly screwing the externally threaded part into the spiral spring portion, and a medical tool can be extended or enlarged by increasingly unscrewing or increasingly removing the externally threaded part from the spiral spring portion.

Additionally or alternatively, the externally threaded part can in particular be screwable into the internally threaded part such that the externally threaded part increasingly protrudes from the internally threaded part. Due to the external and internally threaded parts substantially corresponding to one another, a relative axial movement can in particular be precisely adjustable, for example in order to guide a medical insert, a medical instrument and/or a medication to a predetermined position.

The present screw gear is therefore advantageously suitable for a medical tool that has or requires longitudinal travel, for example, and/or that has or requires actuation with a predeterminable force, and/or that has or requires variability of the stiffness.

The first number of consecutive turns of the spiral spring portion of the internally threaded part, which are not fixed to the outer tube or which are movable relative to the outer tube and which protrude from the outer tube at least partially, can for example be at least two, in particular at least four, preferably at least eight, more preferably at least 15.

As a result, the stiffness of the spiral spring portion can advantageously be precisely adjusted and the screw gear can advantageously be used in a variety of ways. In addition, the screw gear with the first number of consecutive turns, which are not fixed to the outer tube, can advantageously be produced in a simple manner and in particular with little effort, and can also be produced accordingly efficiently.

Furthermore, the spiral can advantageously be provided with application-specific flank heights, application-specific flank angles, and/or application-specific flank shapes, such as sharp thread flanks, trapezoidal thread flanks, sawtooth thread flanks, round thread flanks, and flat thread flanks, by laser cutting the spiral.

In preferred embodiments of the method for producing a screw gear or for producing an internally threaded part, the outer tube can have an outer diameter of less than about 4 mm, in particular less than about 3 mm, preferably less than about 2 mm, for example less than about 1 mm; and/or
the elongated blank can have an outer diameter of less than about 3.7 mm, in particular less than about 2.7 mm, preferably less than about 1.7 mm, for example less than about 1.0 mm, and/or for example more than about 0.3 mm.

By the outer tube and/or the elongated blank each having a correspondingly small outer diameter, a comparatively thin screw gear can advantageously be provided which is suitable for applications with little installation space and which is particularly suitable for a medical tool, such as a longitudinally movable medical tool and/or for a medical tool with adjustable stiffness. The medical tool is therefore particularly suitable for positioning medical inserts, such as stents, for targeted drug administration, and/or for guiding an optical system and/or a cutting agent.

Thread cutting of such thin or small internal threads, in particular of elongated components with thin or small wall thicknesses, is not possible using the known internal thread cutting process.

Accordingly, a particularly thin internally threaded part can be advantageously produced by laser cutting the spiral, which is then fixed to the outer tube, wherein the outer tube in particular has a correspondingly small external diameter as defined above. The particularly thin or small internally threaded part is therefore particularly suitable for a screw gear, together with the remainder of the elongated blank from which the spiral is laser cut.

In further exemplary embodiments, the outer tube can have an outer diameter of less than about 2.5 mm, in particular less than about 2 mm, and/or the elongated blank can have an outer diameter of less than about 2.2 mm, in particular less than about 1.7 mm. In this way, the internally threaded part and the externally threaded part, and accordingly the screw gear, can advantageously be designed to be thin and in particular resource-saving.

In exemplary embodiments, the outer tube can have a wall thickness, i.e a difference between an outer radius and an inner radius, in the range from about 0.1 mm to about 1.2 mm, for example a wall thickness in the range from about 0.2 mm to about 0.4 mm, in particular a wall thickness of about 0.2 mm to about 0.3 mm. In this way, the internally threaded part, and accordingly the screw gear, can advantageously be designed to be thin and in particular resource-saving.

It is understood that the present method is also suitable for larger configurations of screw gears in terms of their outer diameter than those mentioned above by way of example, in particular in order to provide a complementary internal and externally threaded part in a particularly resource-saving and efficient manner, wherein the internally threaded part and the externally threaded part can form a screw gear.

In preferred embodiments of the method for producing a screw gear or for producing an internally threaded part, in the step of fixing the spiral to the outer tube, in particular in the step of partially or completely fixing the spiral to the outer tube, one or more turns of the spiral can be fixed to the outer tube such that the pitch of the one or more tums is compressed or stretched, relative to the pitch of the spiral, as cut out of the elongated blank.

Firstly, an initial clearance or an initial tolerance of the spiral relative to the remainder of the elongated blank can advantageously be defined by means of the laser when laser cutting the spiral, i.e. by the cutting gap of the laser.

By fixing the spiral to the outer tube, a final clearance or a final tolerance of the spiral fixed to the outer tube, which forms the internally threaded part, can then be adjusted relative to the remainder of the elongated blank, which forms the externally threaded part.

By compressing or stretching the pitch of one or more turns, relative to the pitch of the spiral as cut out of the elongated blank, i.e. in an unloaded state of the spiral, the final clearance or the final tolerance can advantageously be adjusted, in particular adjusted to be different from the initial tolerance or the initial clearance.

The method for producing a screw gear or for producing an internally threaded part can accordingly comprise in particular fixing one or more compressed and/or stretched turns at a predetermined position within the outer tube.

If the mutual turns of the internally threaded part and the externally threaded part engage at the predetermined position within the outer tube, the mutual friction of the mutually engaging turns is increased. Accordingly, by fixing the one or more compressed and/or stretched turns at a predetermined position, a predetermined screwing-in torque and/or unscrewing torque can be adjusted. Moreover, by fixing the one or more compressed and/or stretched turns at a predetermined position, a screwing-in torque profile and/or unscrewing torque profile related to the axial relative position of the externally threaded part relative to the internally threaded part can be configured.

The respective torque can be converted into a correspondingly configured force by means of the respective actuation of the relative rotation.

Thus, by fixing the one or more compressed or stretched turns at a predetermined position, a force for rotating the internally threaded part relative to the externally threaded part can be advantageously adjusted by fixing the spiral to the outer tube.

Fixing the spiral to the outer tube can in particular comprise a material-to-material fixing.

Fixing the spiral to the outer tube can in particular comprise welding, preferably laser welding.

This advantageously makes it possible to provide a particularly thin or small internally threaded part, and in turn advantageously makes it possible to provide a particularly thin or small screw gear.

In other exemplary embodiments, fixing the spiral to the outer tube can comprise shrinking the outer tube onto the spiral, for example by gradually heating and cooling the outer tube.

In further exemplary embodiments, fixing the spiral to the outer tube can comprise gluing or soldering the spiral to the outer tube, and/or pressing the spiral into the outer tube, in particular forming an interference fit between the spiral and the outer tube.

By means of the material-to-material fixing and preferably by welding and in particular by laser welding, a long-lasting fixing of the spiral can advantageously be ensured, which is particularly associated with a comparatively low heat input, so that deformation of the spiral during fixing to the outer tube can be reduced or prevented.

In preferred embodiments of the method for producing a screw gear or for producing an internally threaded part, one or more turns of the spiral can be fixed to the outer tube at exactly one point per turn in the step of of fixing the spiral to the outer tube, in particular in the step of of partially or completely fixing the spiral to the outer tube.

It was thus surprisingly found that such fixing of the spiral to the outer tube can already be sufficient for a secure and complementary guidance of the externally threaded part, with only one point per turn being fixed to the outer tube, for example in the sense of one welding point per turn, in particular one laser welding point per turn.

In this way the spiral can advantageously be fixed to the outer tube in a simple and energy-saving manner, and furthermore in a particularly efficient manner, to form the internally threaded part.

Moreover, by fixing one or more turns of the spiral at just one point per turn, one or more tums of the spiral can be fixed to the outer tube with a compressed or stretched pitch compared to the pitch of the spiral in an unloaded state.

In preferred embodiments of the method for producing a screw gear or for producing an internally threaded part, the method can further comprise the step of:
introducing openings into the outer tube, the openings having a distance from one another in the axial direction of the outer tube, which substantially corresponds to the pitch of the spiral.

Openings that are introduced into the outer tube and that have a distance from one another in the axial direction of the outer tube, which substantially corresponds to the pitch of the spiral which the spiral has in an unloaded state, represent in particular first openings.

Openings that are introduced into the outer tube and that have a distance in the axial direction of the outer tube to openings substantially adjacent in the axial direction, which is compressed or stretched relative to the pitch of the spiral which the spiral has in an unloaded state, represent in particular second openings.

Accordingly, the step of introducing openings into the outer tube can comprise at least one step of introducing first openings into the outer tube, wherein the first openings have a distance from one another in the axial direction of the outer tube, which substantially corresponds to the pitch of the spiral in an unloaded state.

Additionally or alternatively, the step of introducing openings into the outer tube can comprise one or more steps of introducing one or more second openings in the outer tube, wherein the one or more second openings have a distance in the axial direction of the outer tube to openings substantially adjacent in the axial direction, which is compressed or stretched relative to the pitch of the spiral in an unloaded state.

The distance of the respective openings as used herein means in particular a distance substantially in the axial direction to openings that are substantially adjacent in the axial direction. It is understood that a distance substantially in the axial direction to adjacent openings that are offset in the circumferential direction and that are arranged on the outer tube offset in the circumferential direction, for example by about 60°, about 90°, about 120°, or about 180°, does not have to correspond to a pitch, and in particular not to a compressed or stretched pitch.

The openings, in particular the first and/or the second openings, can in particular have a diameter in the range of about 0.05 mm to about 1 mm.

The openings introduced into the outer tube advantageously allow the spiral to be fixed to the outer tube in a simple manner, for example by welding, in particular by laser welding.

In addition, the openings introduced advantageously enable simple optical quality control during or after an exemplary step of positioning the spiral in the outer tube. Correct placement of the spiral can be determined in particular if a part of the spiral adjacent to the opening can be seen behind each opening introduced, in other words a view into the outer tube is obscured by the spiral.

In exemplary embodiments, the openings can comprise a predetermined extension substantially in the axial direction of the outer tube and/or substantially in the circumferential direction of the outer tube, in order to particularly ensure reliable optical quality control after a step of positioning the spiral in the outer tube.

A further aspect of the invention relates to a screw gear, wherein the screw gear comprises an internally threaded part and an externally threaded part, wherein the internally threaded part has an internal thread and the externally threaded part has an external thread that substantially corresponds to the internal thread of the internally threaded part,
wherein the internally threaded part is formed in multiple pieces such that the internally threaded part has a spiral and an outer tube, wherein the spiral is fixed to the outer tube.

The present screw gear, which in particular comprises the internally threaded part and the externally threaded part, which have mutually complementary threads, advantageously represents an improved, in particular application-specific configurable screw gear due to the multiple pieces of the internally threaded part.

A further aspect of the invention relates to an internally threaded part that has an internal thread,
wherein the internally threaded part is formed in multiple pieces such that the internally threaded part has a spiral and an outer tube, wherein the spiral is fixed to the outer tube.

Due to its multi-piece design, the present internally threaded part advantageously represents an improved, in particular application-specific configurable internally threaded part, whereby in particular an application-specific configurable screw gear and/or an application-specific configurable screw connection can be formed.

Furthermore, the internally threaded part formed in multiple pieces can advantageously use the spiral that falls off when cutting the external thread of an elongated blank, whereby an internally threaded part and screw gear that is resource-saving and can further be produced particularly efficiently is advantageously provided.

The spiral of the multi-piece internally threaded part can in particular be a spiral that is substantially complementary to the externally threaded part, with a clearance or tolerance between the externally threaded part and the spiral being defined by a cutting gap of the laser in order to separate or cut out the spiral from the externally threaded part by means of laser cutting.

The present method for producing a screw gear, the present method for producing an internally threaded part, as well as their preferred, exemplary and alternative embodiments, and their effects, relate equally to the present screw gear and to the present internally threaded part, as well as their preferred, exemplary and alternative embodiments, and their effects, and vice versa.

In preferred embodiments of the screw gear, the spiral can protrude from the outer tube with a predetermined number of turns, in particular protrude from the outer tube with a predetermined number of consecutive turns.

In preferred embodiments of the internally threaded part, the spiral can protrude from the outer tube with a predetermined number of turns, in particular protrude from the outer tube with a predetermined number of consecutive turns.

The spiral of the internally threaded part can in particular have one or more turns that are movable relative to the outer tube, which are accordingly not fixed to the outer tube.

In exemplary embodiments, the spiral can have a plurality of consecutive turns that are movable relative to the outer tube.

In preferred embodiments, the spiral of the internally threaded part can in particular have a first number of consecutive turns, wherein the turns of the first number of consecutive turns are movable relative to the outer tube, and wherein the turns of the first number of consecutive tums protrude at least partially from the outer tube, in particular protrude at least partially from a first end and/or a second end of the outer tube.

The first number of consecutive turns thereby forms a spiral spring portion of the internally threaded part.

The spring stiffness of the spiral spring portion of the internally threaded part can initially be set by defining the first number of consecutive turns that are movable relative to the outer tube and that in particular protrude from the outer tube.

By screwing the externally threaded part into the internally threaded part, for example by relatively rotating the externally threaded part relative to the internally threaded part, the spring stiffness of the spiral spring portion can be precisely adjusted. In particular, the mobility of some of the turns of the first number of turns can be restricted or in particular blocked by the externally threaded part.

Accordingly, the spring stiffness of the spiral spring portion of the internally threaded part can be variably adjusted by the externally threaded part.

In this case, the externally threaded part can in particular be screwed at least partially into the internally threaded part, and in particular up to an area of the spiral spring portion, in a predetermined manner. By screwing in the externally threaded part, a correspondingly predetermined part of the first number of consecutive turns is restricted and in particular blocked with regard to its mobility relative to the outer tube, so that the spring stiffness of the spiral spring portion is or is being defined by the remaining turns of the first number of consecutive turns that can be moved relative to the outer tube.

Thus, by turning the externally threaded part relative to the internally threaded part, a spring stiffness of the spiral spring portion of the internally threaded part can advantageously be adjusted.

Due to the adjustable stiffness and in particular due to the adjustable spring properties, a tool, for example a medical instrument, can advantageously be operated with a specifically adjustable force.

A further aspect of the invention relates to a medical tool, wherein the medical tool comprises at least one screw gear, as described above.

By the medical tool comprising the screw gear as described above, an improved and in particular resource-saving medical tool is advantageously provided, the longitudinal movability and/or the stiffness of which can advantageously be precisely adjusted.

The present method for producing a screw gear, the present screw gear, the present method for producing an internally threaded part, and the present internally threaded part as well as their preferred, exemplary and alternative embodiments, and their effects, relate equally to the present medical tool, as well as its preferred, exemplary and alternative embodiments, and their effects, and vice versa.

A further aspect of the invention relates to a use of a screw gear as described above and comprises the step of:
rotating at least one of the internally threaded part and the externally threaded part relative to the other of the internally threaded part and the externally threaded part.

The step of rotating at least one of the internally threaded part and the externally threaded part relative to the other of the internally threaded part and the externally threaded part can in particular be carried out such that an axial position of the externally threaded part relative to the internally threaded part is changed.

The step of rotating at least one of the internally threaded part and the externally threaded part relative to the other of the internally threaded part and the externally threaded part can, in exemplary embodiments, be carried out such that an axial position of the externally threaded part relative to the internally threaded part is changed such that the externally threaded part at least partially engages in a first number of consecutive turns of the internally threaded part, wherein the first number of consecutive turns of the internally threaded part is movable relative to the outer tube of the internally threaded part, and wherein the first number of consecutive turns of the internally threaded part protrudes at least partially from the outer tube.

By means of the step of rotating at least one of the internally threaded part and the externally threaded part relative to the other of the internally threaded part, an axial position of the screw gear can advantageously be adjusted precisely, i.e an axial position of the internally threaded part and/or the externally threaded part can advantageously be adjusted precisely, and in particular a stiffness, in particular a spring stiffness of a spiral spring portion of the internally threaded part can advantageously be adjusted precisely.

The present method for producing a screw gear, the present screw gear, the present method for producing an internally threaded part, the present internally threaded part, and the present medical tool, as well as their preferred, exemplary and alternative embodiments, and their effects, relate equally to the present use of a screw gear, as well as its preferred, exemplary and alternative embodiments, and their effects, and vice versa.

The elongated blank, and accordingly the spiral and the externally threaded part, can in particular comprise or consist of a metal, comprise or consist of a plastic, such as polyamide or polyetheretherketone (PEEK), and/or comprise or consist of wood. The elongated blank, and accordingly the spiral and the externally threaded part, can in particular comprise or consist of steel, for example stainless steel, aluminum, a nickel-titanium alloy, and/or another metal.

The outer tube can in particular comprise or consist of a metal, comprise or consist of a plastic, and/or comprise or consist of wood. The outer tube can in particular comprise or consist of steel, for example stainless steel, aluminum, a nickel-titanium alloy, and/or another metal.

In comparison to wood, metals and plastics in particular enable particularly small or thin outer tubes to be used as the outer tube for the internally threaded part, as well as particularly small or thin elongated blanks to be used as the elongated blank for the spindle and/or the externally threaded part.

Embodiments of the invention will be described in more detail below with reference to the accompanying figures. It is understood that the present invention is not limited to these embodiments and that individual features of the embodiments can be combined to form further embodiments within the scope of the accompanying claims.

It is shown:

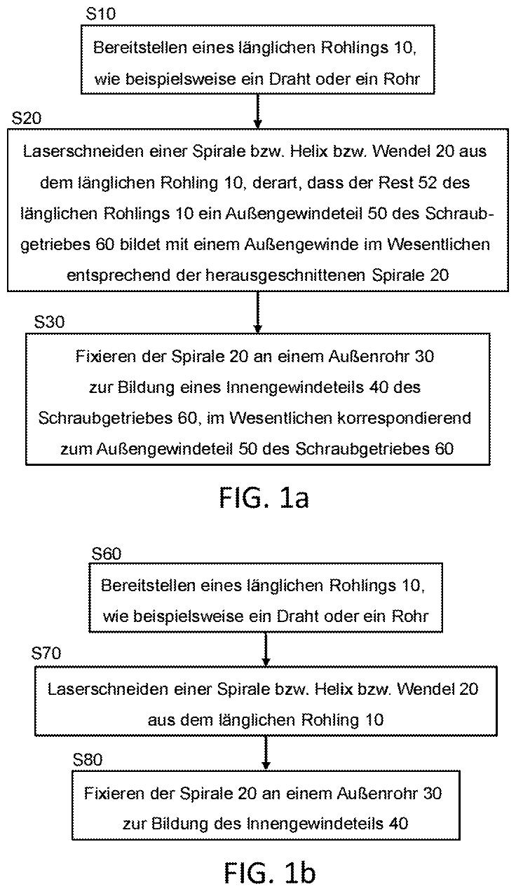

FIG. 1a a flow chart for the method for producing a screw gear according to an embodiment;

FIG. 1b a flow chart for the method for producing an internally threaded part according to an embodiment;

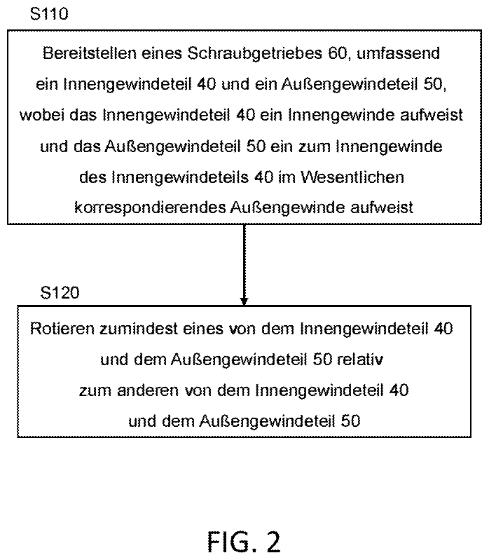

FIG. 2 a flow chart for the use of a screw gear;

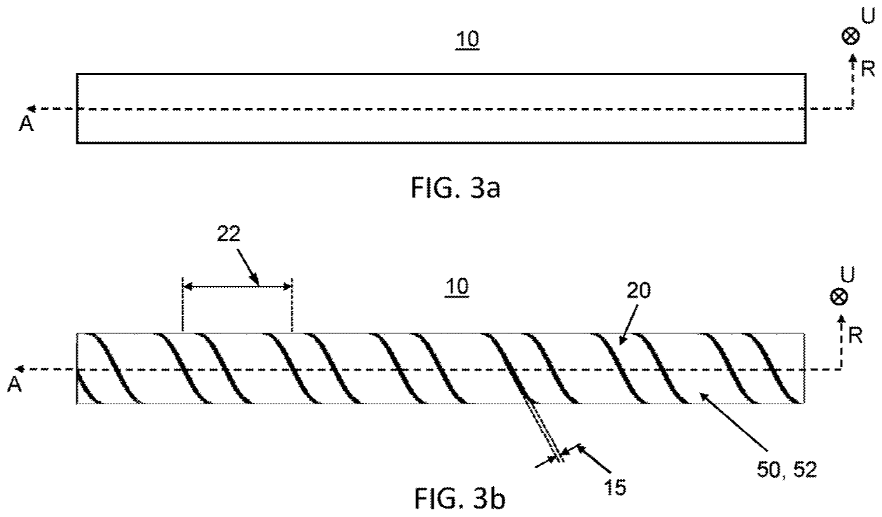

FIG. 3a a sketch of an elongated blank;

FIG. 3b a sketch of a laser-cut elongated blank;

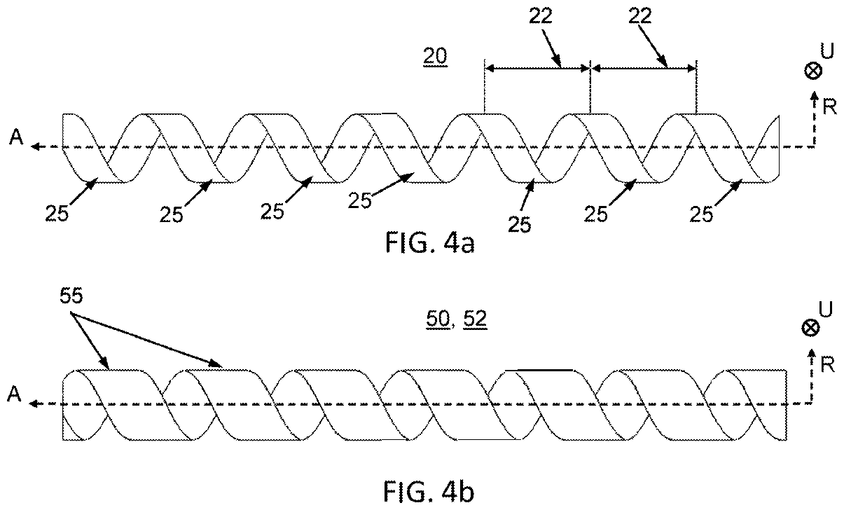

FIG. 4a a sketch of a spiral;

FIG. 4b a sketch of an externally threaded part;

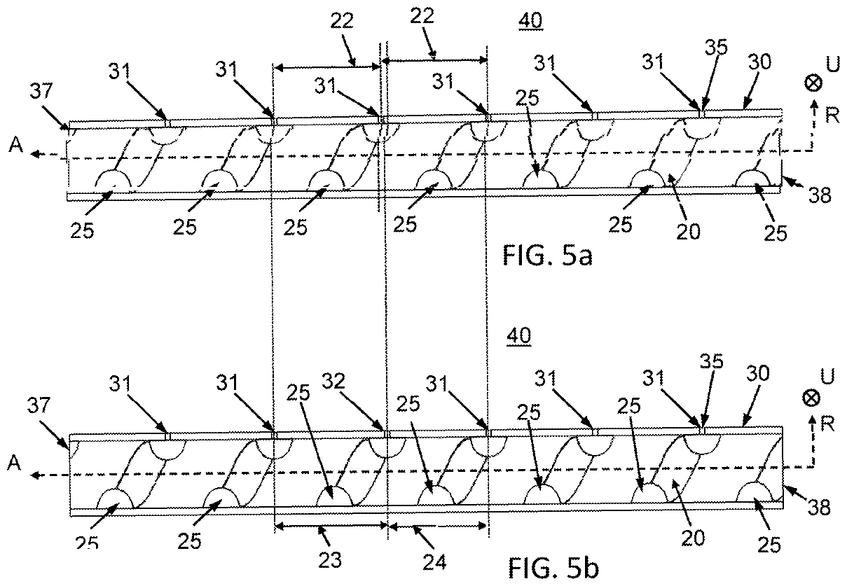

FIG. 5a a sectional view of an exemplary internally threaded part;

FIG. 5b a sectional view of another exemplary internally threaded part;

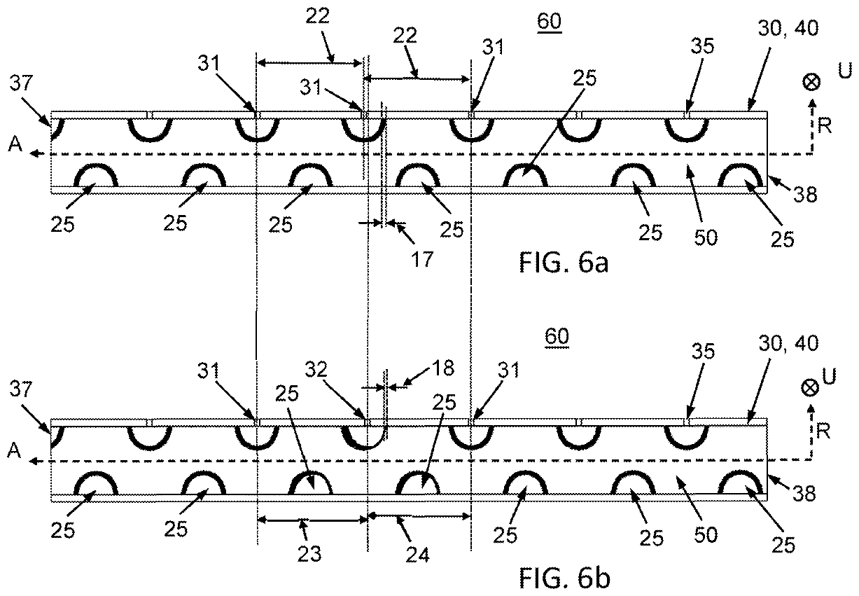

FIG. 6a a sectional view of an exemplary screw gear;

FIG. 6b a sectional view of another exemplary screw gear; and

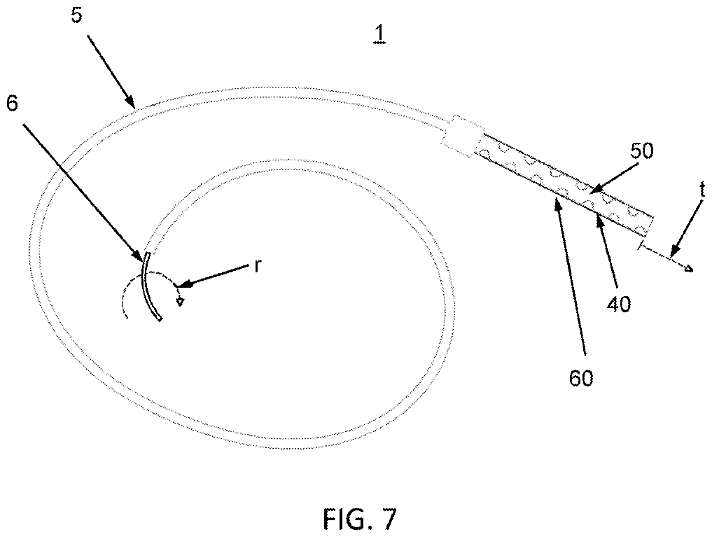

FIG. 7 a sketch of an exemplary medical tool.

FIG. 1a shows a flow chart of an exemplary method for producing a screw gear 60, the method comprising the steps of:
S10: providing an elongated blank 10, such as a wire or a tube;
S20: laser cutting a spiral or helix or spiral coil 20 from the elongated blank 10 such that the remainder 52 of the elongated blank 10 forms an externally threaded part 50 of the screw gear 60, substantially with an external thread corresponding to the cut-out spiral 20; and
S30: fixing the spiral 20 to an outer tube 30 for forming an internally threaded part 40 of the screw gear 60, substantially corresponding to the externally threaded part 50 of the screw gear 60.

The method according to FIG. 1a represents an exemplary method for producing a screw gear 60, and is carried out in particular in this order: S10 prior to S20 and S20 prior to S30.

The method shown in FIG. 1a relates in particular to an elongated blank 10, a spiral or helix or spiral coil 20, an outer tube 30, an internally threaded part 40, an externally threaded part 50, and a screw gear 60, as shown in FIGS. 3a, 3b, 4a, 4b, 5a, 5b, 6a, and 6b.

FIG. 1b shows a flow chart of an exemplary method for producing an internally threaded part 40, the method comprising the steps of:
S60: providing an elongated blank 10, such as a wire or a tube;
S70: laser cutting a spiral or helix or spiral coil 20 from the elongated blank 10; and
S80: fixing the spiral 20 to an outer tube 30 for forming the internally threaded part 40.

The method according to FIG. 1b represents an exemplary method for producing an internally threaded part 40, and is carried out in particular in this order: S60 prior to S70 and S70 prior to S80.

The method shown in FIG. 1b relates in particular to an elongated blank 10, to a spiral or helix or spiral coil 20, to an outer tube 30, and to an internally threaded part 40, as shown in FIGS. 3a, 3b, 4a, 4b, 5a, 5b, 6a and 6b.

Unless otherwise stated, the following statements refer to both methods as shown in FIGS. 1a and 1b.

By laser cutting the spiral or helix or spiral coil 20 from the elongated blank 10, the spiral or helix or spiral coil 20 can advantageously be maintained or obtained as a continuous part. As a result, the spiral or helix or spiral coil 20, which conventionally represents in particular a waste product of the external thread or externally threaded part 50 cut from the elongated blank 10, can advantageously be further used or reused in a simple manner, in particular as an internal thread for the internally threaded part 40, which forms a thread that substantially corresponds to the externally threaded part 50.

The externally threaded part 50 is formed in particular by a remainder 52 of the elongated blank 10, in particular by removing or cutting out the spiral 20 from or out of the elongated blank 10. The removal or cutting out of the spiral 20 takes place in particular by means of a laser as so-called laser cutting.

By fixing or fastening the spiral 20 to the outer tube 30, the internally threaded part 40 is advantageously formed in multiple pieces. This makes it possible to advantageously design the internally threaded part 40 in an application-specific manner, in particular without being subject to the usual restrictions when cutting internal threads, such as in conventional internal thread drilling. Conventional internal thread drilling is difficult at best, particularly with elongated components, as well as with internal threads with small diameters, for example with an outer diameter of less than about 5 mm, in particular less than about 4 mm or less than about 3 mm.

Laser cutting of the spiral 20, which is then fixed to the outer tube 30, thus makes it possible to produce a substantially corresponding internally threaded part 40 for an externally threaded part 50 in a simple and resource-saving manner. Compared to conventional methods, the present method also advantageously makes it possible to produce comparatively long and/or thin internally threaded parts 40 in a reliable manner.

In further exemplary embodiments, the method for producing a screw gear 60 can comprise a step of introducing or forming one or more openings 31, 32 in the outer tube 30, which can be carried out in particular prior to step S30.

The openings 31, 32 advantageously ensure accessibility when fixing the spiral 20 to the outer tube 30, in particular when fixing the spiral 20 to the outer tube 30 in a material-to-material fixing manner. For example, a fixing means 35 can be introduced into the one or more openings 31, 32. The fixing means 35 can in particular be a material-to-material fixing means, such as a weld seam or a welding point, in particular a laser weld seam or a laser welding point.

Accordingly, the spiral 20 can be fixed to the outer tube 30 in a simple manner.

In particular, by means of laser welding, the spiral 20 can be advantageously fixed to the outer tube 30 in a long-lasting manner and with little or even substantially no distortion.

In further exemplary embodiments, the method can include a step of mutually engaging the internally threaded part 40 and the externally threaded part 50. The mutual engagement of the internally threaded part 40 and the externally threaded part 50 comprises in particular the mutual engagement, at least partially, of a turn 25 of the internally threaded part 40 with a turn 55 of the externally threaded part 50.

This can advantageously provide a screw gear 60, wherein the internally threaded part 40 can be turned relative to the externally threaded part 50, so that an axial relative position of the internally threaded part 40 relative to the externally threaded part 50 can be adjusted.

FIG. 2 shows a flow chart of an exemplary use of a screw gear 60, the method comprising the steps of:
S110: providing a screw gear 60 comprising an internally threaded part 40 and an externally threaded part 50, the internally threaded part 40 having an internal thread and the externally threaded part 50 having an external thread substantially corresponding to the internal thread of the internally threaded part 40; and
S120: rotating at least one of the internally threaded part 40 and the externally threaded part 50 relative to the other of the internally threaded part 40 and the externally threaded part 50.

The method according to FIG. 2 shows an exemplary use of a screw gear 60 (e.g. in connection with a medical tool described below) and is carried out in particular in this order: S110 prior to S120.

By rotating or turning the internally threaded part 40 relative to the externally threaded part 50, which substantially have threads substantially corresponding to each other, the relative axial positioning of the internally threaded part 40 relative to the externally threaded part 50 can advantageously be precisely adjusted.

In particular, a precisely adjustable, longitudinally movable screw gear 60 can thus be provided. In other words, a screw gear 60 whose axial relative position between the internally threaded part 40 and the externally threaded part 50 can advantageously be precisely adjusted can in particular be provided.

In exemplary embodiments, the spiral 20 can have one or more turns 25 which, in particular even after the spiral 20 has been fixed to the outer tube 30, are movable relative to the outer tube 30. These one or more turns 25 can protrude at least partially in particular from one end of the outer tube 30, for example from a first end 37 and/or from a second end 38 of the outer tube 30.

By rotating or turning the internally threaded part 40 relative to the externally threaded part 50, which substantially have threads corresponding to one another, in this case a stiffness, in particular a spring stiffness, of a spiral spring portion comprising the one or more turns 25 that are movable relative to the outer tube 30 and that protrude from the outer tube 30 at least partially can advantageously be adjusted.

For example, by increasingly screwing the externally threaded part 50 into the internally threaded part 40, an increasing number of turns 25 that are not directly fixed to the outer tube 30, i.e. that are basically configured to be movable relative to the outer tube 30, can be restricted in their mobility relative to the outer tube and in particular be blocked. In this way, for example, the stiffness or spring stiffness of the spiral spring portion comprising the one or more turns 25 can be increased.

In an analogous manner, by increasingly screwing the externally threaded part 50 out of the internally threaded part 40, a decreasing number of turns 25 that are not directly fixed to the outer tube 30, i.e that are basically configured or mounted to be at least partially movable relative to the outer tube 30, can be loosened in their mobility relative to the outer tube 30 and in particular be released. In this way, for example, the stiffness or spring stiffness of the spiral spring portion comprising the one or more turns 25 can be reduced.

The screwing in or screwing out of the externally threaded part 50 into or out of the internally threaded part 40 is not limited to a rotation of the externally threaded part 50, and can alternatively or additionally comprise a relative corresponding rotation of the internally threaded part 40.

In particular, a precisely adjustable, longitudinally movable screw gear 60 can thus be provided.

FIG. 3a shows a sketch of an elongated blank 10.

As shown in FIG. 3a, the elongated blank 10 can in particular be a blank with a substantially circular outer circumference, in particular in a cross section transverse, i.e substantially perpendicular, to the axial direction A.

The elongated blank 10 can in particular comprise or be a tube having a predetermined outer diameter and a predetermined inner diameter.

In further exemplary embodiments, the elongated blank 10 can comprise or be a wire having a predetermined outer diameter.

It is understood that an initial component of the elongated blank 10 is not limited to a substantially round cross-section, but can in particular also have edges. However, the elongated blank 10 with a substantially round cross-section advantageously enables a spiral 20 with a correspondingly predefined external diameter to be cut from it in a simple manner, and, in particular integrally or simultaneously, an externally threaded part 50 with a correspondingly defined external thread to be cut.

As sketched in FIG. 3a, the elongated blank 10 can have a length in the axial direction A which is multiple times greater than a dimension of the elongated blank 10 substantially perpendicular to the axial direction A, i.e. than a diameter of the elongated blank 10.

For example, a length of the elongated blank 10 in the axial direction A can be at least about 2 times as large, in particular 5 times as large, preferably at least about 10 times as large, particularly preferably at least about 20 times as large, as a dimension of the elongated blank 10 substantially perpendicular to the axial direction A or as a dimension of the cross section of the elongated blank 10.

For example, the elongated blank 10 can have a length of more than about 5 mm, in particular have a length of more than 80 mm, preferably of more than 150 mm, more preferably of more than 200 mm, particularly preferably of more than 300 mm.

The elongated blank 10 can for example have an outer diameter or a cross section substantially perpendicular to the axial direction A of less than about 6 mm, in particular less than about 5 mm, preferably less than about 4 mm, more preferably less than about 3.5 mm, even more preferably less than about 3 mm, particularly preferably less than about 2.5 mm, furthermore less than about 2 mm, for example less than about 1.5 mm or less than about 1 mm.

As a result, starting from the elongated blank 10, a particularly thin screw gear 60 can advantageously be provided, which is suitable for applications with little installation space and in particular for a medical tool 1.

However, it is understood that the elongated blank 10 is not limited to this, and is in particular also suitable for a screw gear 60 with a larger cross section and/or a different length than the cross sections and lengths mentioned above as examples.

FIG. 3b shows a sketch of a laser-cut elongated blank 10, in particular the elongated blank 10 as shown in FIG. 10, after a laser cutting step S20.

The laser cutting of the elongated blank 10 can in particular comprise a combination of a feed movement substantially along the axial direction A, a rotational movement substantially in the circumferential direction U, and a tilting or inclining movement of the laser relative to the axial direction A in order to apply a laser cut that divides the elongated blank 10 into a spiral or helix or spiral coil 20 and an externally threaded part 50 or into a remainder 52 of the elongated blank 10.

The spiral 20 and the remainder 52 of the elongated blank 10 can in particular be adjacent to one another after laser cutting, as shown in FIG. 3b, in particular with a cutting gap 15 of the laser which separates the spiral 20 from the remainder 52 of the elongated blank 10.

After laser cutting, the spiral 20 can be removed from the remainder 52 of the elongated blank 10. For example, the spiral 20 can be removed from the elongated blank 10 by turning the spiral 20 against the remainder 52 of the elongated blank 10, or for example by manually or mechanically unwinding or pulling the spiral 20 from the remainder 52 of the elongated blank 50.

FIG. 4a shows a sketch of a spiral or helix or spiral coil 20, in particular the spiral or helix or spiral coil 20, as shown in FIG. 3b, but in a representation separated from the remainder 52 of the elongated blank 10.

As illustrated by FIGS. 3b and 4a, the pitch 22 or the slope of the spiral 20, and/or the extension of a turn 25 of the spiral 20 in the axial direction A, and/or the extension of a turn 25 of the Spiral 20 in the radial direction R, can be predefined.

Accordingly, the mechanical properties, such as in particular stiffness or spring stiffness, as well as flexibility or bending stiffness of the spiral 20, can advantageously be adjusted by means of laser cutting in a predefined manner.

FIG. 4b shows a sketch of an externally threaded part 50, in particular corresponding to the remainder 52 of the elongated blank 10, in particular as shown in FIG. 3b.

As illustrated by FIGS. 3b, 4a and 4b, the spiral 20 and the externally threaded part 50 or the remainder 52 of the elongated blank 10 have substantially mutually corresponding contours.

The externally threaded part 50 has in particular an external thread, the negative of which substantially corresponds to the spiral 20.

The externally threaded part 50 can comprise a closed outer circumferential contour in exemplary embodiments. The closed outer circumferential contour of the externally threaded part 50 does not have openings in the radial direction R toward the axis of the externally threaded part 50, which can substantially correspond to the axial direction A shown in FIG. 4b. This can advantageously improve mutual guidance between the externally threaded part 50 and the spiral 20, in particular in a screw gear 60, as shown for example in FIGS. 6a and 6b.

As illustrated by FIGS. 3b and 4b, the pitch or the slope of the external thread of the externally threaded part 50, and/or the extension of a turn 55 of the externally threaded part 50 in the axial direction A, and/or the extension of a turn 55 of the externally threaded part 50 in the radial direction R, can advantageously be predefined by means of laser cutting.

Accordingly, the mechanical properties, such as in particular stiffness or spring stiffness, as well as flexibility or bending stiffness of the externally threaded part 50 can advantageously be adjusted by means of laser cutting in a predefined manner.

FIG. 5a shows a sectional view of an exemplary internally threaded part 40, in particular an internally threaded part 40, which comprises the spiral or helix or spiral coil 20, as shown in FIG. 4a. The sectional view relates in particular to a section of an internally threaded part 40 with a cutting plane along the axial direction A and the radial direction R.

FIG. 5b shows a sectional view of another exemplary internally threaded part 40, in particular an internally threaded part 40, which comprises the spiral or helix or spiral coil 20, as shown in FIG. 4a. The sectional view relates in particular to a section of an internally threaded part 40 with a cutting plane along the axial direction A and the radial direction R.

The internally threaded parts 40 shown in FIGS. 5a and 5b can in particular comprise a geometrically substantially identical or an identical spiral or helix or spiral coil 20.

As shown in FIGS. 5a and 5b, the internally threaded part 40 comprises an outer tube 30 configured to receive a spiral or helix or spiral coil 20, in particular a spiral or helix or spiral coil 20 as shown in FIG. 4a.

In preferred embodiments, the inner diameter of the outer tube 30 corresponds substantially to the outer diameter of the spiral 20. This advantageously facilitates fixing the spiral 20 to the outer tube 30, i.e. in particular to an inner circumferential side of the outer tube 30.

In exemplary embodiments, the outer tube 30 and the spiral 20 are formed such that the inner diameter of the outer tube 30 forms a transition fit or a clearance fit with the outer diameter of the spiral 20 at least partially.

Alternatively or additionally, the outer tube 30 and the spiral 20 can be formed such that the inner diameter of the outer tube 30 forms a press fit with the outer diameter of the spiral 20 at least partially.

The transition fit and in particular the clearance fit enable the spiral 20 to be placed or positioned in the outer tube 30 in an advantageously simple manner, wherein the pitch 22 of the spiral 20 or the pitch 22 of the turns 25 of the spiral 20 is substantially maintained, in particular when the spiral 20 is placed or positioned in the outer tube 30 at least partially.

In contrast, the press fit enables particularly firm fixing of the spiral 20 in the outer tube 30.

Furthermore, the press fit enables particularly targeted local placement or positioning of the spiral 20 in the outer tube 30, wherein the pitch 22 of the spiral 20 or the pitch 22 of the turns 25 of the spiral 20 can be influenced in a targeted manner, and can be specifically adjusted at least partially to an extended pitch 23 or a compressed pitch 24.

The extended pitch 23 has a larger dimension in the axial direction A relative to the pitch 22. The compressed pitch 24 has a smaller dimension in the axial direction A relative to the pitch 22. Accordingly, the compressed pitch 24 has a smaller dimension in the axial direction A relative to the extended pitch 23.

The spiral 20 can be fixed to the outer tube 30 in a material-to-material fixing manner, in particular by means of welding, for example by means of laser welding.

The spiral 20 can be completely accommodated in the outer tube 30, or protrude from the outer tube 30 partially with a predetermined number of turns 25.

An embodiment in which the spiral 20 is completely accommodated in the outer tube 30 is particularly suitable for a precise, application-specific, longitudinally movable screw gear 60, in particular for a medical tool 1 provided therewith.

An embodiment in which the spiral 20 protrudes at least partially from a first end 37 or a second end 38 of the outer tube 30 is particularly suitable for a screw gear 60 that has an end with adjustable stiffness or spring stiffness. The stiffness or spring stiffness of one end of the internally threaded part 40 is adjustable in particular using a first number of consecutive turns 25 that are movable relative to the outer tube 30 and thereby form a spiral spring portion.

By inserting the externally threaded part 50 into the internally threaded part 40, in particular into the spiral spring portion of the first number of consecutive turns 25, the number of free turns as part of the initially configured first number of turns 25, which are movable relative to the outer tube 30, can be actively adjusted.

This embodiment is therefore particularly suitable for a precise, application-specific, longitudinally movable and stiffness-adjustable screw gear 60, in particular for a medical tool 1 provided therewith, wherein a predetermined ratio of travel to applied force can be precisely adjusted. Such a precisely adjustable ratio of travel to applied force is suitable for example for targeted drug administration, for placing medical inserts, such as stents, in the body, and for other tools, for example when treating tissue with a targeted force.

In exemplary embodiments, the outer tube 30 has one or more openings 31, 32. The multiple openings 31, 32 can in particular be arranged on the outer tube 30 so as to be distributed substantially along the axial direction A. A portion of the multiple openings 31, 32 can optionally also be arranged on the outer tube 30 so as to be distributed in particular along the circumferential direction U.

In exemplary embodiments, the multiple openings 31, 32 can be arranged on the outer tube 30 so as to be distributed along the axial direction A and offset from one another along the circumferential direction U. In particular, openings 31, 32 that are adjacent to one another can be spaced apart from one another both in the axial direction A and in the circumferential direction U. The distance of the openings 31, 32 that are adjacent to one another can in particular correspond substantially to the radially outer contour of the turns 25 of the spiral 20, which are arranged or positioned at least partially within the outer tube 30.

As shown in FIGS. 5a and 5b, in exemplary embodiments the outer sleeve 30 can have exactly one row of openings 31, 32. In other words, openings 31, 32 adjacent to one another in the axial direction A can in particular have no relative offset to one another in the circumferential direction U. In other words, at least some of the multiple openings 31, 32 can be arranged in a single row on the outer tube 30 with respect to the circumferential direction U.

The at least partially single-row arrangement of openings 31, 32 on the outer tube 30 advantageously enables a comparatively simple introduction of openings 31, 32 on the outer tube 30.

Openings 31, 32 can be arranged or formed on the outer tube 30 for example by means of a drill or by means of laser cutting.

The openings 31, 32 on the outer tube 30 advantageously enable the spiral 20 to be easily fixed to the outer tube 30, in particular by fixing the spiral 20 to the outer tube 30 in the area of the openings 31, 32.

The spiral 20 can be fixed to the outer tube 30 at least at some of the openings 31, 32, for example by means of welding, in particular by means of laser welding.

In further exemplary embodiments, the spiral 20 can be fixed to at least some of the openings 31, 32 by means of gluing, as an alternative or in addition to welding, in particular laser welding.

For example, the spiral 20 (based on the elongated blank 10) can comprise or consist of a metal, such as stainless steel, aluminum, and/or a nickel-titanium alloy, and can be fixed for example by means of gluing and/or welding, in particular laser welding, to the outer sleeve 30, which in particular comprises or consists of a metal, such as stainless steel, aluminum, and/or a nickel-titanium alloy, and/or comprises or consists of a plastic, such as polyamide or polyetheretherketone (PEEK), and/or comprises or consists of wood.

Alternatively or additionally, the spiral 20 that is based on the elongated blank 10 can comprise or consist of a plastic, such as polyamide or polyetheretherketone (PEEK), for example, and can be fixed for example by means of gluing and/or welding, in particular laser welding, to the outer sleeve 30, which in particular comprises or consists of a metal, such as stainless steel, aluminum, and/or a nickel-titanium alloy, and/or comprises or consists of a plastic, such as polyamide or polyetheretherketone (PEEK), and/or comprises or consists of wood.

Further alternatively or additionally, the spiral 20 that is based on the elongated blank 10 can comprise or consist of wood, for example, and can be fixed for example by means of gluing and/or welding to the outer sleeve 30, which in particular comprises or consists of a metal, such as stainless steel, aluminum, and/or a nickel-titanium alloy, and/or comprises or consists of a plastic, such as polyamide or polyetheretherketone (PEEK), and/or comprises or consists of wood.

In exemplary embodiments, the spiral 20 can be fixed to the outer tube 30 in a single row with respect to the circumferential direction U, in particular substantially corresponding to an at least partially single-row arrangement of openings 31, 32 on the outer tube 30.

This can advantageously simplify fixing of the spiral 20 to the outer tube 30, which further advantageously reduces the manufacturing effort of the screw gear 60 as a whole.

Furthermore, single-row fixing of the spiral 20 with respect to the circumferential direction U enables the turns 25 to each have a portion that is fixed relative to the outer tube 30 and a portion that is movable relative to the outer tube 30. In the area of the movable portion of the turns 25, a clearance between the internal thread of the internally threaded part 40 and the external thread of the externally threaded part 50 can advantageously adjust itself, or a clearance between the spiral 20 of the internally threaded part 40 and the external thread of the externally threaded part 50 can adjust itself. This advantageously ensures relative mobility of the internally threaded part 40 relative to the externally threaded part 50 for a long time.

Single-row fixing of the spiral 20 to the outer tube 30 relates in particular to fixing in which the turns 25 of the spiral 20, which are being fixed or are fixed to the outer tube 30, are being fixed or are fixed to the outer tube 30 only at one point per turn 25, wherein the points at which the turns 25 are fixed are aligned in particular substantially in the axial direction A.

As illustrated by FIGS. 5a and 5b, the openings 31, 32 can be or are arranged or formed at predetermined distances from one another on the outer tube 30. If the openings 31, 32 are arranged or formed in a row that is aligned substantially in the axial direction A, the openings 31, 32 can be spaced from one another in particular substantially in accordance with the pitch 22 of the turns 25 of the spiral 20.

As shown by way of example in FIG. 5a, the outer tube 30 can have a plurality of first openings 31, which are arranged or formed on the outer tube 30 at a substantially uniform distance from one another. The first openings 31 can each have a distance from first openings 31 adjacent in the axial direction A that substantially corresponds to the pitch 22 of the turns 25 of the spiral 20, in particular with regard to the spiral 20 in an unloaded or relaxed state.

As shown by way of example in FIG. 5b, the outer tube 30 can have one or more second openings 31, in particular in addition to a plurality of first openings 31, which are arranged or formed analogously to the first openings 31 according to FIG. 5a. The second openings 32 can each have a distance from first openings 31 adjacent in the axial direction A that is different from the pitch 22 of the turns 25 of the spiral 20, in particular with regard to the spiral 20 in an unloaded or relaxed state.

A corresponding second opening 32 can for example have a distance from a first opening 31 adjacent in the axial direction A that is greater or smaller than the pitch 22 of the turns 25 of the spiral 20, in an unloaded state of the spiral 20. Additionally or alternatively, the second opening 32 can have a distance from another first opening 31 adjacent in the axial direction A that is greater or smaller than the pitch 22 of the turns 25 of the spiral 20, in an unloaded state of the spiral 20.

A turn 25 of the spiral 20, which is fixed to the outer tube 30 with a dimension relating to the pitch that is larger than the pitch 22, has in particular a comparatively extended pitch 23 or an extended pitch 23. A turn 25 of the spiral 20, which is fixed to the outer tube 30 with a dimension relating to the pitch that is smaller than the pitch 22, has in particular a comparatively compressed pitch 24 or a compressed pitch 24.

Accordingly, one turn 25 of multiple turns 25 of the spiral 20 can be fixed in particular at a location on the outer tube 30 such that it has a pitch 22 that substantially corresponds to the pitch 22 of the turns 25 of the spiral 20 in an unloaded state, can be fixed at a location on the outer tube 30 such that it has an extended pitch 23 which is enlarged compared to the pitch 22 of the turns 25 of the spiral 20 in an unloaded state, i.e. is extended, or can be fixed at a location on the outer tube 30 such that it has a compressed pitch 24 which is reduced compared to the pitch 22 of the turns 25 of the spiral 20 in an unloaded state, i.e. is compressed.

In comparison to the internally threaded part 40 as shown in FIG. 5a, the outer tube 30 as shown in FIG. 5b has in particular a second opening 32 that has a different distance in the axial direction A relative to the adjacent first openings 31 than other first openings 31.

In further exemplary embodiments of an internally threaded part 40, the internally threaded part 40 or the outer tube 30 of the internally threaded part 40 can have multiple second openings 32. Multiple second openings 32 can be arranged at least partially in the axial direction A adjacent to first openings 31, or can be arranged one after the other in the axial direction A.

The necessary force or the necessary torque for the relative rotation between the externally threaded part 50 and the internally threaded part 40 can advantageously be adjusted in a targeted manner through the second opening(s) 32.

In preferred embodiments, as shown in FIG. 5b, a second opening 32, in particular a second opening 32 of multiple second openings 32, can be arranged on the outer tube 30 such that the second opening 32 is arranged in the axial direction A between two first openings 31. In particular, the two first openings 31, which surround the second opening 32 in the axial direction A, can be spaced from each other substantially by twice the pitch 22 of the turns 25 of the spiral 20. This preferred arrangement of first and second openings 31, 32 allows the necessary force or the necessary torque for the relative rotation between the externally threaded part 50 and the internally threaded part 40 to be advantageously specifically adjusted on individual turns 25 of the internally threaded part 40, wherein it is further advantageously ensured that the further turns 25, 55 of the internally threaded part 40 and the externally threaded part 50 engage with each other with comparatively less friction.

By arranging multiple second openings 32 on an outer tube 30, a necessary force profile or a necessary torque profile for relative rotation between the externally threaded part 50 and the internally threaded part 40 can be advantageously adjusted.

FIG. 6a shows a sectional view of an exemplary screw gear 60, which in particular comprises an internally threaded part 40 as shown in FIG. 5a, and which in particular comprises an externally threaded part 50 as shown in FIG. 4b. The sectional view relates in particular to a section of a screw gear 60 with a cutting plane along the axial direction A and the radial direction R. Possible turns 25 of the spiral 20 protruding from the outer tube 30 of the internally threaded part 40 are not shown, but can be present according to the previous explanations.

FIG. 6b shows a sectional view of another exemplary screw gear 60, which in particular comprises an internally threaded part 40 as shown in FIG. 5b, and which in particular comprises an externally threaded part 50 as shown in FIG. 4b. The sectional view relates in particular to a section of a screw gear 60 with a cutting plane along the axial direction A and the radial direction R. Possible turns 25 of the spiral 20 protruding from the outer tube 30 of the internally threaded part 40 are not shown, but can be present according to the previous explanations.

As shown by way of example in FIG. 6a, the turns 25 of the spiral 20 can be fixed in particular at points on the outer tube 30 that are or are being spaced apart from one another in the axial direction A, the respective distance substantially corresponding to the pitch 22 of the turns 25 of the spiral 20 in a relaxed state of the spiral 20. The turns 25 of the spiral 20 can in particular be fixed at least partially to first openings 31, as explained with reference to FIG. 5a.

By fixing the turns 25 to the outer tube 30 substantially according to the pitch 22, the internal thread of the internally threaded part 40 and the external thread of the externally threaded part 50 have in particular an initial tolerance 17 or an initial clearance 17. The initial tolerance 17 or the initial clearance 17 shown in FIG. 6a represents in particular a tolerance or a clearance that is formed in the axial direction A on an outer section of the turns 25, 55 of the internally threaded part 40 and the externally threaded part 50 in the radial direction R. The initial tolerance 17 or the initial clearance 17 is based in particular on the cutting gap 15 of the laser, as shown in FIG. 3b.

As shown by way of example in FIG. 6b, the turns 25 of the spiral 20 can be or are fixed in particular at points of the outer tube 30 that are spaced apart from one another in the axial direction A, wherein the distance partially, i.e. for a portion of the turns 25, substantially corresponds to the pitch 22 of the turns 25 of the spiral 20 in a relaxed state of the spiral 20, and wherein the distance partially, i.e. for one or more turns 25, deviates or is different from the pitch 22 of the turns 25 of the spiral 20 in a relaxed state of the spiral 20. The turns 25 of the spiral 20 can in particular be fixed at least partially to first openings 31 and to one or more second openings 32, as explained with reference to FIGS. 5a and 5b.

By fixing the turns 25 to the outer tube 30 at least partially deviating from the pitch 22, the internal thread of the internally threaded part 40 and the external thread of the externally threaded part 50 have in particular a final tolerance 18 or a final clearance 18. The final tolerance 18 or the final clearance 18 shown in FIG. 6b represents in particular a tolerance or a clearance that is formed in the axial direction A on an outer portion of the turns 25, 55 of the internally threaded part 40 and the externally threaded part 50 in the radial direction R, and which deviates from the initial tolerance 17 or the initial clearance 17. The final tolerance 18 or the final clearance 18 is based in particular on the initial tolerance 17 or on the initial clearance 17, as shown in FIG. 6a, wherein the initial tolerance 17 or the initial clearance 17 is changed by the spacing of the successively fixed turns 25 that deviates from the pitch 22 or is different.

While the initial tolerance 17 or the initial clearance 17, as shown by way of example in FIG. 6a, enables a continuous, smooth rotation of the internally threaded part 40 relative to the externally threaded part 50, the final tolerance 18 or the final clearance 18, as shown by way of example in FIG. 6b, enables targeted adjustment of a friction force between the internally threaded part 40 and the externally threaded part 50, and accordingly adjustment of a necessary force or a necessary torque for rotating the internally threaded part 40 and the externally threaded part 50 relative to one another.

FIG. 7 shows an example medical tool 1.

As shown in FIG. 7, the medical tool 1 can comprise one or more screw gears 60, as described by way of example with reference to FIGS. 1 to 6. Due to the one or more screw gears 60, the medical tool 1 can in particular be a longitudinally movable medical tool 1, and/or a medical tool 1 with adjustable stiffness.

As shown in FIG. 7, the medical tool 1 can in particular comprise a catheter 5, which is designed in particular for insertion into a body, for example for insertion into a living or dead body.

The catheter 5 can in particular comprise a tube, for example with or made of plastic, rubber, silicone, metal or glass. As shown in FIG. 7, a means 6 can be arranged at least partially in the catheter 5, in particular arranged substantially concentrically to the catheter 5 in the catheter 5.

The means 6 can be arranged in the catheter 5 so that it can move relative to the catheter 5. The means 6 can be arranged in the catheter 5 so that it can rotate relative to the catheter 5 and/or move translationally relative to the catheter 5.

The catheter 5 can be arranged in particular at one end of the screw gear 60 or be indirectly connected to the screw gear 60.

The catheter 5 and/or the means 6, which is guided and/or held in the catheter 5, can be coupled or connected to one of the internally threaded part 40 and the externally threaded part 50, for example. The coupling or connection is designed in particular such that a rotational movement of the externally threaded part 50 relative to the internally threaded part 40 leads to a corresponding rotational and/or translational movement of the catheter 5 and/or the means 6.

As shown in FIG. 7 using the translational arrow t and the rotational arrow r, the medical tool 1 can for example comprise an actuator or a conversion mechanism, wherein a rotational movement of the catheter 5 and/or a means 6, which is guided and/or held in the catheter 5, is converted into a translational or longitudinal movement.

The medical tool 1 can be designed in particular for positioning medical inserts, such as stents, for targeted drug administration, and/or for guiding an optical system and/or a cutting means. Accordingly, a means 6 guided and/or held in the catheter 5 can for example comprise one or more medical inserts, such as one or more stents, one or more drugs, one or more optics and/or one or more cutting means.

In exemplary embodiments, the means 6 arranged in the catheter 5 can be coupled to the externally threaded part 50 and the catheter 5 can be coupled to the internally threaded part 40. The externally threaded part 50 and the internally threaded part 40 together form in particular a screw gear 60, as described above. The coupling of the catheter 5 to the internally threaded part 40 and/or the coupling of the means 6 to the externally threaded part 50 can for example comprise a substantially rigid connection.

By means of a relative rotation of the externally threaded part 50 relative to the internally threaded part 40, the means 6 can be arranged in the catheter 5 so that it can be moved translationally relative to the catheter 5. As a result, the means 6 is designed to be at least partially extendable out of the catheter 5 and at least partially retractable into the catheter 5.

In further exemplary embodiments, the means 6 can be a rotation transmission means, wherein the rotation transmission means can be driven in the direction of rotation, for example by a rotation drive, which can be coupled in particular to a control and/or regulating unit.

The rotation transmission means can be coupled in particular to one of the externally threaded part 50 and the internally threaded part 40, in particular can be coupled substantially rigidly. The other of the externally threaded part 50 and the internally threaded part 40 can for example be arranged in a rotationally fixed manner, in particular on the catheter 5, without being limited thereto.

By rotating the rotation transmission means, the externally threaded part 50 can advantageously be turned relative to the internally threaded part 40 and a translational movement of the externally threaded part 50 relative to the internally threaded part 40 can be effected, for example toward an organ or away from an organ.

In this case, one or more medical inserts can be arranged at a distal end of at least one of the externally threaded part 50 and the internally threaded part 40. The one or more medical inserts can for example comprise one or more stents, be designed for targeted drug administration, and/or be designed to guide an optical system and/or a cutting means.

The present medical tool 1 can for example be designed for artificial nutrition, for the intravenous supply of nutrients and/or drugs, in particular chemotherapeutic agents, to the body, for example through infusions.

Furthermore, the present medical tool 1 can comprise or form a fixed catheter and furthermore in particular comprise a port, wherein the port can connect the catheter 5 to a vein.

In further exemplary embodiments, the medical tool 1 can be designed to be used in keyhole operations, in particular on the coronary arteries and/or on the leg arteries. In this case, calcified arteries can be widened and/or stents can be implanted. The medical tool 1 can for example comprise or form a balloon catheter with which narrowed arteries can be widened.

The balloon catheter can optionally be coated with one or more active substances so that the arteries remain open for a long time. When the arteries widen, known as dilatation, they might be damaged, which creates the risk that the vessel will narrow again. To prevent this, the balloon catheter can be coated with a substance that inhibits cell growth to prevent reclosure.

In exemplary embodiments, the medical tool 1 can comprise one or more stents that can be implanted in leg arteries, for example. To this end, the medical tool 1 can comprise an inner catheter to which the stent is mounted. It can be guided by a movable outer catheter, such as shown as catheter 5 in FIG. 7. The inner and outer catheters can be pushed into the artery and the stent can be released by a translational relative movement between the externally threaded part 50 and the internally threaded part 40, in particular to unfold in the blood vessel. A long stent can have a length of more than 200 mm, for example.

However, a long stent can lead to complications in areas of the body that are moved a lot, for example in the knee area. As an alternative to a long stent, multiple short stents can be mounted on the inner catheter, which are shorter than the long stent. Multiple short stents can be positioned one after the other at different narrow points in the artery.

By means of the screw gear 60, comprising the externally threaded part 50 and the internally threaded part 40, the medical inserts, such as stents in particular, and als, for example medications, nutrients, optical systems, cutting agents and/or a port, can advantageously be positioned precisely in the body.

If the externally threaded part 50 and the internally threaded part 40 have a nickel-titanium alloy, for example, the sterility or hygiene as well as the flexibility of the medical tool 1 can advantageously be improved thereby.

### LIST OF REFERENCE NUMERALS

1 medical tool
5 catheter
6 means
10 elongated blank
15 cutting gap of the laser
17 initial tolerance or initial clearance
18 final tolerance or final clearance
20 spiral or helix or spiral coil
22 pitch (of the spiral in an unloaded state)
23 extended pitch
24 compressed pitch
25 turn (of the spiral)
30 outer tube
31 first opening
32 second opening
35 fixing means
37 first end (of the outer tube)
38 second end (of the outer tube)
40 internally threaded part
50 externally threaded part
52 remainder (of the elongated blank)
55 turn (of the externally threaded part)
60 screw gear
A axial direction
r rotational arrow
R radial direction
S10-S30 steps of a method for producing a screw gear
S60-S80 steps of a method for producing an internally threaded part
S110-S120 steps of using a screw gear
t translational arrow
U circumferential direction

1. A method for producing a screw gear, the method comprising the steps of:
providing an elongated blank, such as a wire or a tube;
laser cutting a spiral or helix or spiral coil from the elongated blank such that the remainder of the elongated blank forms an externally threaded part of the screw gear, substantially with an external thread corresponding to the cut-out spiral; and
fixing the spiral to an outer tube to form an internally threaded part of the screw gear, substantially corresponding to the externally threaded part of the screw gear.

2. A method for producing an internally threaded part, the method comprising the steps of:
providing an elongated blank, such as a wire or a tube;
laser cutting a spiral or helix or spiral coil from the elongated blank; and
fixing the spiral to an outer tube to form the internally threaded part.

3. The method according to claim 1, wherein in the step of fixing the spiral to the outer tube, the spiral is fixed to the outer tube such that a predetermined number of turns of the spiral protrude from the outer tube.

4. The method according to claim 1, wherein the outer tube has an outer diameter of less than about 4 mm; and/or
the elongated blank has an outer diameter of less than about 3.7 mm.

5. The method according to claim 1, wherein in the step of fixing the spiral to the outer tube one or more turns of the spiral are fixed to the outer tube such that the pitch of the one or more turns is compressed or stretched, relative to the pitch of the spiral, as cut out of the elongated blank.

6. The method according to claim 1, wherein in the step of fixing the spiral to the outer tube one or more turns of the spiral are fixed to the outer tube at exactly one point per turn.

7. The method according to claim 1, further comprising the step of:
introducing openings into the outer tube, the openings having a distance from one another in the axial direction of the outer tube, which substantially corresponds to the pitch of the spiral.

8. A screw gear comprising an internally threaded part and an externally threaded part, wherein the internally threaded part has an internal thread and the externally threaded part has an external thread that substantially corresponds to the internal thread of the internally threaded part,
wherein the internally threaded part is formed in multiple pieces such that the internally threaded part has a spiral or helix or spiral coil and an outer tube, wherein the spiral is fixed to the outer tube.

9. An internally threaded part having an internal thread, wherein the internally threaded part is formed in multiple pieces such that the internally threaded part has a spiral or helix or spiral coil and an outer tube, wherein the spiral is fixed to the outer tube.

10. The screw gear according to claim 8, wherein the spiral protrudes from the outer tube with a predetermined number of turns.

11. A medical tool comprising at least one screw gear according to claim 8.

12. A use of a screw gear according to claim 8, comprising the step of:
rotating at least one of the internally threaded part and the externally threaded part relative to the other of the internally threaded part and the externally threaded part.

13. The method according to claim 1, wherein the outer tube has an outer diameter of less than about 3 mm; and/or the elongated blank has an outer diameter of less than about 2.7 mm.

14. The method according to claim 1, wherein the outer tube has an outer diameter of less than about 2 mm; and/or the elongated blank has an outer diameter of less than about 1.7 mm.

15. The internally threaded part according to claim 9, wherein the spiral protrudes from the outer tube with a predetermined number of turns.

16. A medical tool comprising at least one screw gear according to claim 10.

17. A use of a screw gear according to claim 10, comprising the step of:
rotating at least one of the internally threaded part and the externally threaded part relative to the other of the internally threaded part and the externally threaded part.

18. The method according to claim 2, wherein in the step of fixing the spiral to the outer tube, the spiral is fixed to the outer tube such that a predetermined number of turns of the spiral protrude from the outer tube.

19. The method according to claim 2, wherein the outer tube has an outer diameter of less than about 3 mm; and/or the elongated blank has an outer diameter of less than about 2.7 mm.

20. The method according to claim 2, wherein the outer tube has an outer diameter of less than about 2 mm; and/or the elongated blank has an outer diameter of less than about 1.7 mm.
